(19) United States
(12) Patent Application Publication
(10) Pub. No.: US 2026/0084311 A1
(43) Pub. Date: Mar. 26, 2026

(54) GENERATING ROBOTIC CONTROL POLICIES VIA DIFFUSION DISTILLATION

(71) Applicant: NVIDIA Corporation, Santa Clara, CA (US)

(72) Inventors: Zhendong Wang, San Jose, CA (US); Yu Zeng, San Jose, CA (US); Zhaoshuo Li, Santa Clara, CA (US); Yogesh Balaji, Mountain View, CA (US); Jiaojiao Fan, Santa Clara, CA (US); Ming-Yu Liu, Redwood City, CA (US); Linxi Fan, San Jose, CA (US); Ajay U. Mandlekar, Cupertino, CA (US); Yashraj Narang, Mountain View, CA (US); Yuke Zhu, Austin, TX (US); Zhenjia Xu, Mountain View, CA (US)

(21) Appl. No.: 19/092,452

(22) Filed: Mar. 27, 2025

Related U.S. Application Data
(60) Provisional application No. 63/697,741, filed on Sep. 23, 2024.

(51) Int. Cl. B25J 9/16

(52) U.S. Cl. CPC B25J 9/1697; B25J 9/163; B25J 9/1679

(57) ABSTRACT

Apparatuses, systems, and techniques related to robotic control policies via diffusion distillation. In at least one embodiment, an action generation system processes image data in a single (one-step) pass to quickly generate action controls.

### CLAIM OF PRIORITY

This application claims the benefit of U.S. Provisional Application Ser. No. 63/697,741 (Attorney Docket No. 515212) titled “Robotic Control Policies via Diffusion Distillation,” filed Sep. 23, 2024, the entire contents of which is incorporated herein by reference.

### TECHNICAL FIELD

At least one embodiment pertains to using distillation of diffusion models for robotic control policies.

### BACKGROUND

Robot control needs to be fast for real-time applications and to adapt to dynamically changing environments. While diffusion models have been successful at generative tasks, they are slow due to iterative processing. There is a need for addressing these issues and/or other issues associated with the prior art.

### BRIEF DESCRIPTION OF THE DRAWINGS

The present systems and methods for robotic control policies via diffusion distillation are described in detail below with reference to the attached drawing figures, wherein:

FIG. 1A is a block diagram illustrating an example one-step action generation system, according to at least one embodiment.

FIG. 1B illustrates example images that are processed to generate actions, according to at least one embodiment.

FIG. 1C is a block diagram illustrating an example action generator, according to at least one embodiment.

FIG. 1D illustrates a flowchart of a method for generating actions, according to at least one embodiment.

FIG. 2A is a block diagram illustrating an example diffusion distillation system, according to at least one embodiment.

FIG. 2B is a block diagram illustrating another example diffusion distillation system, according to at least one embodiment.

FIG. 3A illustrates a flowchart of a method for training an action generator neural network model, according to at least one embodiment.

FIG. 3B illustrates a flowchart of another method for training an action generator neural network model, according to at least one embodiment.

FIG. 4 illustrates a parallel processing unit (“PPU”), according to at least one embodiment.

FIG. 5A illustrates a processing system implemented using the PPU of FIG. 4, according to at least one embodiment.

FIG. 5B illustrates an exemplary system in which the various architecture and/or functionality of the various previous embodiments may be implemented, according to at least one embodiment.

FIG. 5C illustrates an exemplary system that can be used to train a machine learning model, according to at least one embodiment.

FIG. 6 illustrates an exemplary streaming system, according to at least one embodiment.

### DETAILED DESCRIPTION

Systems and methods are disclosed related to generating or refining robotic control policies via diffusion distillation. An action generation system processes image data in a single (one-step) pass to quickly generate action controls. Compared with conventional diffusion-based solutions that predict actions at 1.5 Hz, in at least one embodiment, the action generation system increases the action prediction frequency to 62 Hz. Furthermore, in at least one embodiment, only 2-10% additional training is needed to achieve the real-time action prediction performance.

Teaching robots to conduct tasks through human demonstration is a promising direction for creating capable robots. A visuomotor policy defines a mapping for generating actions given environment conditions and image observations. Recently, a capability of modeling complex distributions, as demonstrated by success in image and video generation, has enabled diffusion models to learn visuomotor policies. However, diffusion models perform time consuming iterative denoising to generate each output sample (e.g., action). The slow sampling speed hinders the use of diffusion models for robotic control. In contrast, the action generation system is a one-step diffusion model that does not require iterative denoising for generating robot actions and therefore, generates samples faster than conventional diffusion models while achieving accuracy that is comparable to the conventional diffusion models.

A diffusion policy for one or more tasks is defined by a pre-trained teacher neural network. The teacher neural network may be pre-trained using images and ground truth actions for one or more tasks. In one or more non-limiting example implementations of the present disclosure, example robotic action tasks can include (without limitation), tasks such as: push, square, tool hang, transport, pick-and-place, lift, or can (place into a bin or container). The diffusion policy defined by the teacher neural network is distilled into a one-step diffusion-based action generator neural network model, maximizing inference efficiency through a single neural network feedforward operation. The pre-trained teacher neural network is used to train the action generator neural network model, computing scores for the actions predicted by the action generator neural network model in response to training image data. A loss function updates the diffusion policy parameters, used by the action generator neural network model, based on a loss computed in score space.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

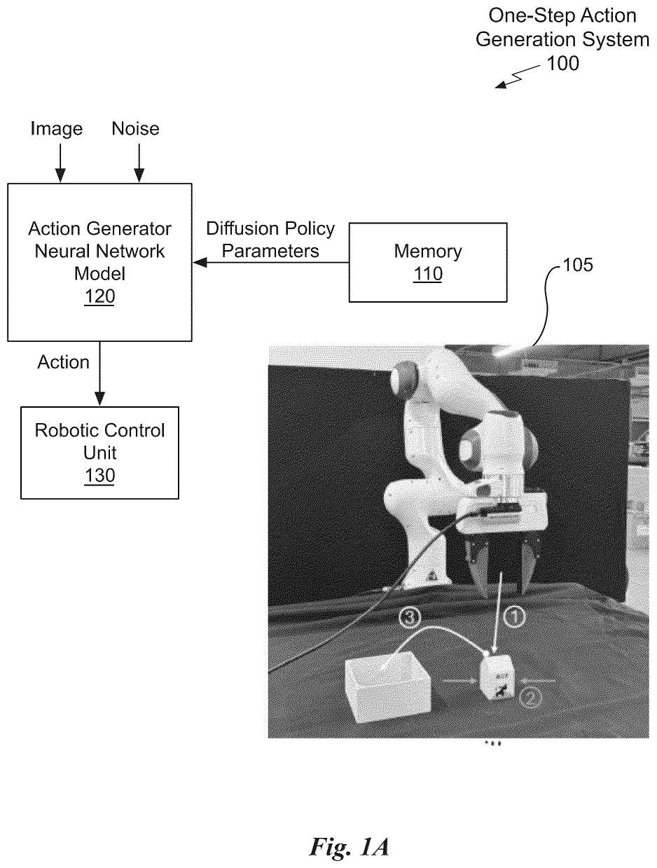

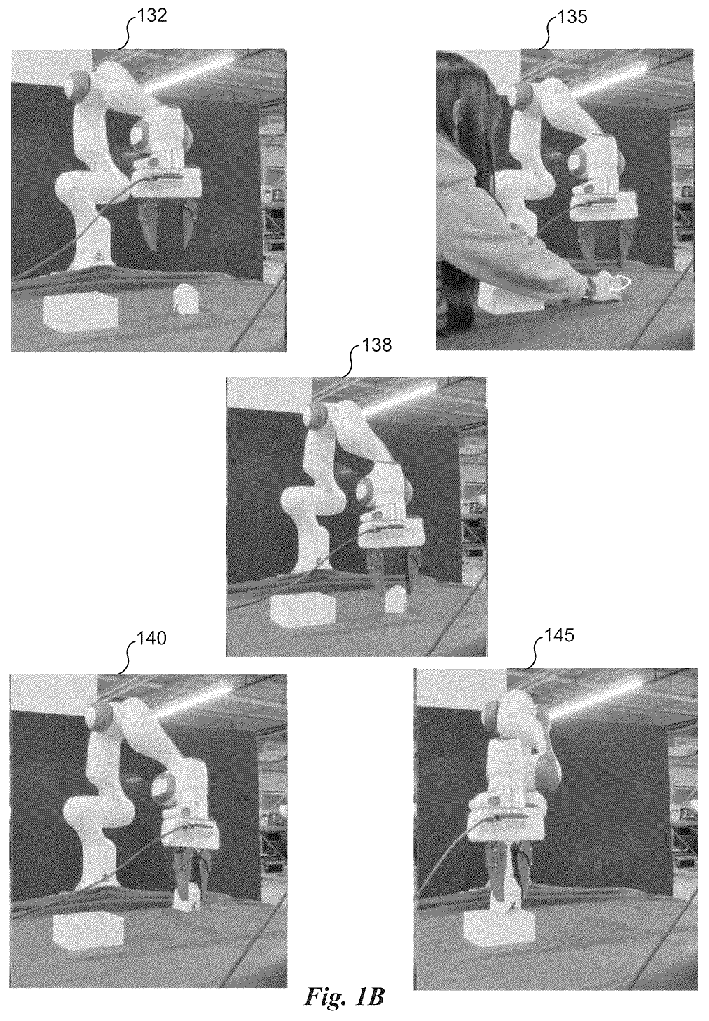

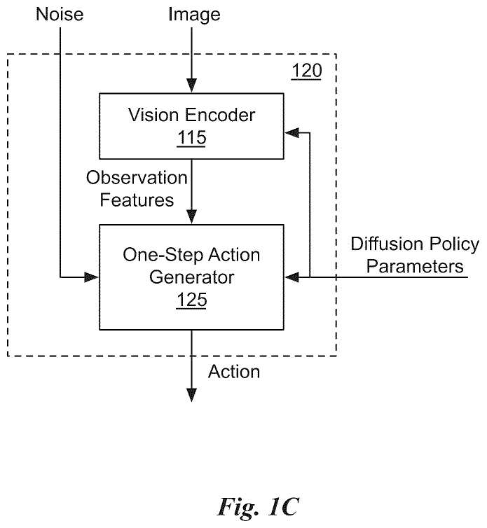

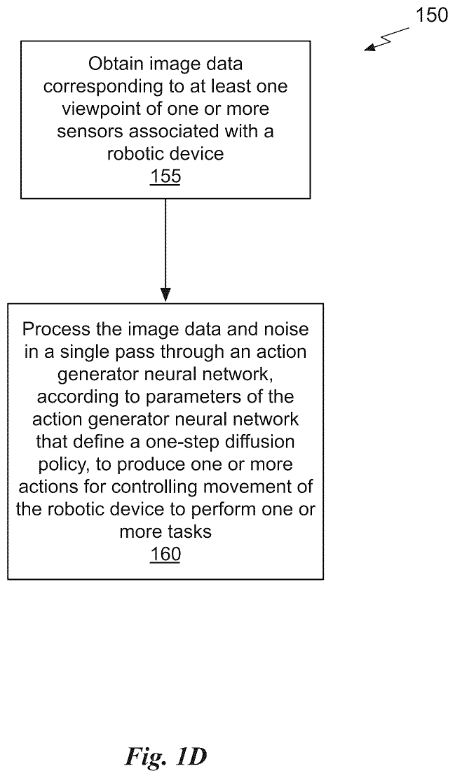

FIG. 1A is a block diagram illustrating an example one-step action generation system 100, according to at least one embodiment. In at least one embodiment, a diffusion policy for controlling robotic actions has been distilled into the one-step action generation system 100 and the one-step action generation system 100 is then deployed to generate actions for controlling a robot. Image 115 illustrates a robot performing a pick-and-place task. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the one-step action generation system 100 is within the scope and spirit of embodiments of the present disclosure.

The one-step action generation system 100 includes an action generator neural network model 120, a robotic control unit 130, and a memory 110 that stores diffusion policy parameters (weights) defining a one-step diffusion policy. The action generator neural network model 120 receives image data associated with a robotic device. In at least one embodiment, image data includes one or more images captured from different viewpoints in an environment in which the robotic device performs the actions. In at least one embodiment, the image data is a sequence of images captured over time as the actions are performed. The viewpoints (e.g., of one or more cameras or other sensors) may be located on the robotic device and/or in the environment.

The action generator neural network model 120 processes the image data and noise in a single processing pass, applying the diffusion policy parameters, to produce one or more actions for controlling movement of the robotic device to perform the task. In an embodiment, the noise is random noise. The robotic control unit 130 converts the actions into control signals for the robotic device. In at least one embodiment, the action generator neural network model 120 directly generates the control signals for the robotic device. As shown in the image 115, the generated sequence of actions for the pick-and-place task are: “1. Move to the milk box,” “2. Grasp the milk box,” and “3. Put the milk box into a box.”

To generate actions, a classical diffusion model traverses the reverse diffusion chain which involves multiple iterations, with each iteration passing through the same denoising network several—potentially thousands of—times. Such a long inference time restricts the practicality of using the diffusion policy, which by default runs at 1.49 Hz, in scenarios where quick response and low computational demands are essential. The slow generation process of conventional diffusion models presents significant limitations for robotic task applications. While classical tasks like block stacking or part assembly may accommodate slower inference rates, more dynamic activities involving human interference or changing environments require quicker control responses. Compared with the conventional diffusion models, the action generator neural network model 120 dynamically responds to changes, such as the human interference or changing environments, while continuing to perform the task. Inference time for the action generator neural network model 120 is reduced through diffusion distillation, enabling the action generator neural network model 120 to dynamically respond to the changing environment.

FIG. 1B illustrates example images that are processed to generate actions, according to at least one embodiment. A sequence of the example images 132, 135, 138, 140, and 145 may be input to the one-step action generation system 100 to generate a sequence of corresponding actions for the pick-and-place task. The image 132 shows the robot positioned above the milk box, preparing to pick up the milk box. During the milk box pick-and-place task, the milk box pose is randomly reset by human intervention, as shown in image 135, to simulate changes in the environment. The image 138 shows the robot repositioned and grasping the milk box. The image 140 shows the robot lifting the milk box and the image 145 shows the robot preparing to place the milk box into the box. Experimental results indicate that a conventional pre-trained backbone diffusion policy achieves a success rate of 28.57%, while the action generator neural network model 120 achieves a success rate of 76.19%, over 21 random initializations. The conventional pre-trained backbone diffusion policy fails in most cases due to having a slow response to environmental changes, whereas the action generator neural network model 120 reacts quickly and achieves a much higher success rate.

FIG. 1C is a block diagram illustrating an example action generator neural network model 120, according to at least one embodiment. The action generator neural network model 120 includes a vision encoder 115 and a one-step action generator 125, each of which may be implemented as software, hardware, or a combination. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the action generator neural network model 120 is within the scope and spirit of embodiments of the present disclosure.

The vision encoder 115 processes the images (image-based visual observations) to encode observation features. In at least one embodiment, the images are associated with image data captured using sensors at different viewpoints. In at least one embodiment, the vision encoder 115 comprises a ResNet based vision encoder. The vision encoder 115 receives a portion of the diffusion policy parameters. During training, the portion of the diffusion policy parameters used by the vision encoder 115 and the diffusion policy parameters used by the one-step action generator 125 are learned. The one-step action generator 125 converts the observation features and noise into actions, applying the diffusion policy parameters to the images and input noise to predict the actions. In at least one embodiment, the noise is random noise.

FIG. 1D illustrates a flowchart of a method 150 for generating actions, according to at least one embodiment. Each block of method 150, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 150 is described, by way of example, with respect to the one-step action generation system 100 and the action generator neural network model 120 of FIGS. 1A and 1C, respectively. However, this method may additionally or alternatively be executed by any one system, or any combination of systems, including, but not limited to, those described herein. Furthermore, persons of ordinary skill in the art will understand that any system that performs method 150 is within the scope and spirit of embodiments of the present disclosure.

At step 155, image data corresponding to at least one viewpoint of one or more sensors associated with a robotic device is obtained. In at least one embodiment, the action generator neural network comprises an image encoder that processes at least the image data to produce one or more observation features. In at least one embodiment, the at least one viewpoint includes at least one of a first viewpoint associated with a sensor located on the robotic device or a second viewpoint of a sensor used to capture image data depicting at least a portion of the robotic device.

At step 160, the image data and noise are processed in a single pass through an action generator neural network, according to parameters of the action generator neural network that define a one-step diffusion policy, to produce one or more actions for controlling movement of the robotic device to perform one or more tasks. In at least one embodiment, the one or more tasks comprise at least one of push, square, tool hang, transport, pick-and-place, lift, or can. In at least one embodiment, the one-step diffusion policy defines the one or more tasks. In at least one embodiment, the one-step diffusion policy is distilled from an iterative diffusion policy.

In at least one embodiment, at least one of step 155 or step 160 is performed within a cloud computing environment. In at least one embodiment, at least one of step 155 or step 160 is performed for training, testing, or certifying a neural network employed in a machine, the robotic device, or autonomous vehicle. In at least one embodiment, at least one of step 155 or step 160 is performed on a virtual machine comprising a portion of a graphics processing unit. In at least one embodiment, at least one of step 155 or step 160 is implemented to include advanced error correction, fault-tolerance, or self-healing capabilities.

In at least one embodiment, an object to which at least one task of the one or more tasks is applied is manipulated by an external force that is independent of the robotic device while the at least one task is performed. An example of such an external force is illustrated in image 135 of FIG. 1B. In at least one embodiment, a next action of the one or more actions is produced responsive to an image depicting a result due to the external force. An example image depicting the next action is illustrated in image 138 of FIG. 1B.

### One-Step Diffusion Policy Distillation

Diffusion models are powerful generative models that function by defining a forward diffusion process that gradually corrupts the data distribution into a known noise distribution. Given a data distribution p(x), the forward process adds Gaussian noise to samples, x⁰˜p(x), with each step defined as x^{k}=αₖx⁰+σₖϵₖ, where ϵₖ˜ [symbol] (0, 1). The parameters αₖ and σₖ are manually designed and vary according to different noise scheduling strategies.

A probabilistic model p_{θ}(x^{k-1}|x^{k}) is then trained to reverse the diffusion process, enabling data generation from pure noise. Denoising diffusion probabilistic models use discrete-time scheduling with a noise prediction model ϵ_{θ} to parameterize p_{θ}, while elucidating diffusion models employ continuous-time diffusion with x⁰-prediction. In at least one embodiment, epsilon prediction ϵ_{θ} is used and a diffusion model within the one-step action generation system 100 is trained using a denoising score matching loss.

Once trained, an unknown score s(x^{k}) at a diffused sample x^{k} is estimated as:

$$s ( {x}^{k} ) = - \frac{{ϵ}^{*} ( {x}^{k} , k )}{{σ}_{k}} \approx - \frac{{ϵ}_{θ} ( {x}^{k} , k )}{{σ}_{k}} \qquad Eq . ( 1 )$$

where ϵ*(x^{k}, k) is the true noise added at time k and

$${s}_{θ} ( {x}^{k} ) = - \frac{{ϵ}_{θ} ( {x}^{k} , k )}{{σ}_{k}} .$$

With a score estimate, clean data x⁰ can be sampled by reversing the diffusion chain. The reverse diffusion process requires multiple iterations through the estimated score network, making it inherently slow.

In robotics, a set of past observation images, O, is used as input to a diffusion policy, such as a visuomotor policy for action controls. An action chunk, A, which is a sequence of consecutive actions, forms the output of the diffusion policy. Diffusion policy is represented as a conditional diffusion-based action prediction model,

$${π}_{θ} ( {A}^{0} \vert 0 ) := \int … \int 𝒩 ( {A}^{K} ; 0 , I ) {\prod }_{k = K}^{k = 1} {p}_{θ} ( {A}^{k - 1} \vert {A}^{k} , O ) d {A}^{K} … {dA}^{1} , \qquad Eq . ( 2 )$$

The explicit form of π_{θ}(A⁰|O) is often impractical due to the complexity of integrating actions from A^{K} to A¹. However, action chunk samples can be obtained by iterative denoising.

Action sampling through vanilla diffusion policies is notoriously slow due to the need of tens to hundreds of iterative inference steps. The latency issue is critical for computationally sensitive robotic tasks or tasks that require high control frequency. Although employing advanced ordinary differential equation (ODE) solvers could help speed up the sampling procedure, empirically at least ten iterative steps are required to ensure reasonable performance. Therefore, a training-based diffusion policy distillation method is used to transfer knowledge of a pre-trained diffusion policy into the one-step action generation system 100, enabling fast action sampling.

In at least one embodiment, the diffusion policy for one or more tasks is defined by a pre-trained teacher neural network. The teacher neural network may be pre-trained using images and ground truth actions for one or more tasks. The diffusion policy is distilled into the action generator neural network model 120 using the pre-trained teacher neural network to train the one-step action generator 125 and the vision encoder 115. A loss function updates the diffusion policy parameters based on a loss computed in score space. The pre-trained teacher neural network computes scores for the actions predicted by the action generator neural network model 120 in response to training image data.

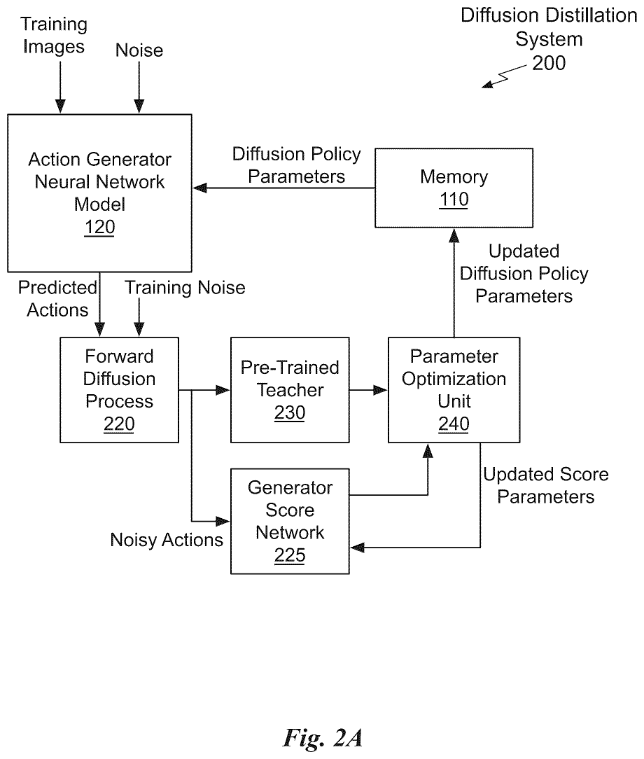

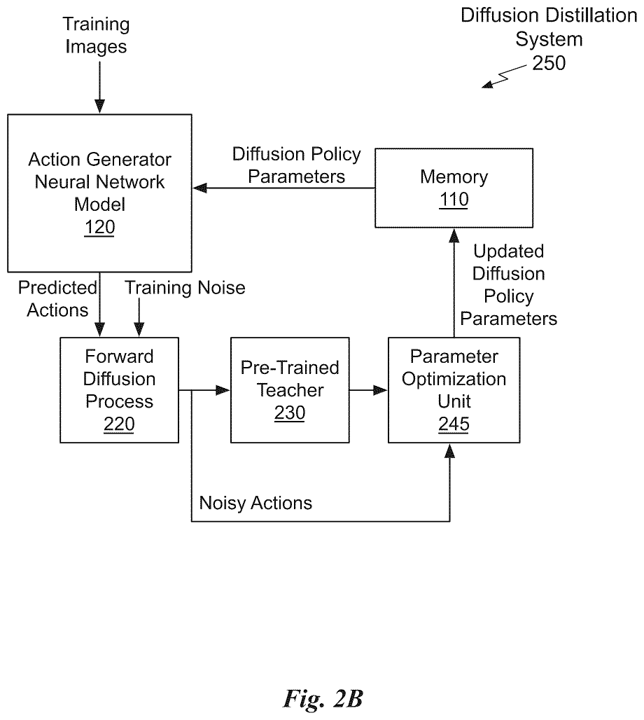

FIG. 2A is a block diagram illustrating an example diffusion distillation system 200, according to at least one embodiment. The diffusion policy distillation system 200 includes the action generator neural network model 120, the memory 110, a forward diffusion process 220, pre-trained teacher 230, generator score network 225, and parameter optimization unit 240, each of which may be implemented as software, hardware, or a combination. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the diffusion distillation system 200 is within the scope and spirit of embodiments of the present disclosure.

The action generator neural network model 120 processes the training images and noise according to the diffusion policy parameters to generate predicted actions. The forward diffusion process 220 combines the predicted actions with training noise, producing noisy actions. In at least one embodiment, the amount of training noise increases as the training progresses. Diffusion models, such as the pre-trained teacher 230, are robust generative models utilized across various domains. Diffusion models operate by establishing a forward diffusion process that incrementally transforms a data distribution into a known noise distribution, such as standard Gaussian noise. A probabilistic model, such as the one-step action generator 125, is trained to methodically reverse this diffusion process, enabling the generation of data samples from pure noise.

For a data distribution p(x), the forward diffusion process is performed by gradually adding Gaussian noise to samples x⁰˜p(x) as follows,

$${x}^{k} = {α}_{k} {x}^{0} + {σ}_{k} {ϵ}_{k} , {ϵ}_{k} ∼ 𝒩 ( 0 , I ) ; q ( {x}^{k} \vert {x}^{0} ) := 𝒩 ( {α}_{k} {x}^{0} , {σ}_{k}^{2} I )$$

where αₖ and σₖ are parameters manually designed to vary according to different noise scheduling strategies. For a discrete-time diffusion model, k∈{1, . . . , K}. The diffusion model can be easily extended to continuous-time diffusion from the score-based generative model perspective with k∈[0,1]. With a sufficient amount of noise added, x^{K}≃ [symbol] (0, 1). In at least one embodiment, the diffusion process is reversed to iteratively reconstruct the original sample x⁰ by training a neural network ϵ_{θ}(x^{k}, k) to predict the noise ϵₖ added at each forward diffusion step (epsilon prediction). With reparameterization ϵₖ=(x^{k}−αₖx⁰)/σₖ, the diffusion model could also be formulated as a x⁰-prediction process x_{θ}(x^{k}, k). In at least one embodiment, epsilon prediction ϵ_{θ} is used to train the action generator neural network model 120.

The action generator neural network model 120 may be trained in a stochastic mode or a deterministic mode. The generator score network 225 is used for the stochastic mode and is omitted for the deterministic mode (see FIG. 2B). The noise input to the action generator neural network model 120 is also omitted for the deterministic mode. The pre-trained teacher 230 processes the noisy actions and computes scores. Specifically, the pre-trained teacher 230 comprises a pre-trained score network that generates scores based on the pre-trained diffusion policy. When the action generator neural network model 120 is trained in the stochastic mode, the generator score network 225 is jointly trained with the action generator neural network model 120 and computes predicted scores for the noisy actions according to score parameters.

To align the action generator neural network model 120 distribution with the pre-trained policy distribution of the pre-trained teacher 230, Kullback-Leibler (KL) divergence is minimized over diffused actions produced by the action generator neural network model 120, with the gradient of the KL expressed as a score difference loss. In at least one embodiment, because direct computation of the KL divergence is impractical, the gradient of the KL is formulated into a score-difference loss. The parameter optimization unit 240 receives the scores computed by the pre-trained teacher 230 and the predicted scores, and computes updated diffusion policy parameters for the action generator neural network model 120 and updated score parameters for the generator score network 225 based on a score-difference loss. In at least one embodiment, the parameter optimization unit 240 computes a the denoising score matching loss,

$${min}_{θ} {𝔼}_{{x}^{k} ∼ q ( {x}^{k} \vert {x}^{0} ) , {x}^{0} ∼ p ( x ) , k ∼ 𝒰} [ λ ( k ) \cdot {‖ {ϵ}_{θ} ( {x}^{k} , k ) - {ϵ}_{k} ‖}^{2} ]$$

where [symbol] is a uniform distribution over the k space, and λ(k) is a noise-ratio re-weighting function.

In at least one embodiment, the expectational reverse KL divergence is minimized by the parameter optimization unit 240. In other words, the reverse KL divergence between the one-step output and the iterative denoising output is minimized. Because reverse KL divergence typically induces mode-seeking behavior, which contributes to robust and consistent action prediction, reverse KL divergence can mitigate the effect of low-quality human demonstrations in training data, and improve success rate.

In an embodiment, before training, the structure and weights of both the generator score network 225 and the action generator neural network model 120 are initialized to equal the pre-trained teacher 230. After training is complete, the diffusion policy parameters define the action generator neural network model 120. A consistency policy is applied to speed up sampling by enforcing self-consistency along the diffusion model's denoising process, so that fewer denoising steps gives results similar to that of more denoising steps. By initializing the action generator neural network model 120 and the generator score network 225 with the identical pre-trained teacher 230, performance of the original model is preserved and/or enhanced, and only 2%-10% additional pre-training cost is incurred for the diffusion policy distillation to converge. The diffusion policy distillation produces a higher success rate across tasks, leveraging a single-step action generator neural network model 120 and achieving 20% faster convergence compared with conventional distillation techniques.

A one-step implicit action generator G_{θ}, such as the action generator neural network model 120, from which actions can be obtained is as follows,

$$z ∼ 𝒩 ( 0 , I ) , {A}_{θ} = {G}_{θ} ( z , O ) . \qquad Eq . ( 3 )$$

An action distribution generated by G_{θ} is defined as p_{G}_{_{θ}}. Assuming the existence of a pre-trained diffusion policy π_{φ}(A|O), such as the pre-trained teacher 230, defined by Equation (2) and parameterized by ϵ_{φ}, has a corresponding action distribution is denoted as p_{π}_{_{φ}}. Drawing inspiration from the success of score distillation systems (SDS) and variational score distillation (VSD) in text-to-3D applications, the following reverse KL divergence is used to align the distributions p_{G}_{_{θ}}, and p_{π}_{_{φ}},

$${𝒟}_{K L} ( {p}_{{G}_{θ}} ‖ {p}_{{π}_{ϕ}} ) = {𝔼}_{z ∼ 𝒩 ( 0 , I ) , {A}_{θ} = {G}_{θ} ( z , O )} [ log {p}_{{G}_{θ}} ( {A}_{θ} \vert O ) - log {p}_{{π}_{ϕ}} ( {A}_{θ} \vert O ) ] .$$

It is generally intractable to estimate a loss by directly computing the probability densities, since p_{G}_{_{θ}} is an implicit distribution and p_{π}_{_{φ}} involves integrals that are impractical (see Equation (2)). However, only the gradient with respect to θ is needed to train the one-step action generator neural network model 120 by gradient descent:

$${∇}_{θ} {𝒟}_{K L} ( {p}_{{G}_{θ}} ‖ {p}_{{π}_{ϕ}} ) = {𝔼}_{{z \sim 𝒩 ( 0 , I ) ,}_{{A}_{θ} = {G}_{θ} ( z , O )}} [ ( {∇}_{{A}_{θ}} log {p}_{{G}_{θ}} ( {A}_{θ} \vert O ) - {∇}_{{A}_{θ}} log {p}_{{π}_{θ}} ( {A}_{θ} \vert O ) ) {∇}_{θ} {A}_{θ} ] . \qquad Eq . ( 4 )$$

### Here

$${s}_{{p}_{{G}_{θ}}} ( {A}_{θ} ) = {∇}_{{A}_{θ}} log {p}_{{G}_{θ}} ( {A}_{θ} \vert O ) and {s}_{{p}_{{π}_{ϕ}}} ( {A}_{θ} ) = {∇}_{{A}_{θ}} log {p}_{{π}_{ϕ}} ( {A}_{θ} \vert O )$$

are the scores of the p_{Gθ} and p_{π}_{_{φ}} respectively. Computing the gradient still presents two significant challenges: First, the scores tend to diverge for samples from p_{G}_{_{θ}} that have a low probability in p_{π}_{_{φ}}, especially when p_{π}_{_{φ}} may approach zero. Second, the primary tool for estimating these scores, the diffusion models, only provide scores for the diffused distribution.

The KL divergence outlined in Equation (4) is optimized across diffused action samples as described below:

$${∇}_{θ} {𝔼}_{k \sim 𝒰} [ {𝒟}_{K L} ( {p}_{{G}_{θ} , k} ‖ {p}_{{π}_{ϕ} , k} ) ] = {𝔼}_{{{z \sim 𝒩 ( 0 , I ) , k \sim 𝒰}_{{A}_{θ} = {G}_{θ} ( z , O )}}_{{A}_{θ}^{k} \sim q ( {A}_{θ}^{k} \vert {A}_{θ} , k )}} [ w ( k ) ( {s}_{{p}_{{G}_{θ}}} ( {A}_{θ}^{k} ) - {s}_{{p}_{{π}_{ϕ}}} ( {A}_{θ}^{k} ) ) {∇}_{θ} {A}_{θ}^{k} ] . \qquad Eq . ( 5 )$$

could be where w(k) is a reweighting function, q is the forward diffusion process and

$${s}_{{p}_{{π}_{ϕ}}} ( {A}_{θ}^{k} )$$

could be obtained through Equation (1) with ϵ_{φ}. In order to estimate the score of the generator distribution

$${s}_{{p}_{{G}_{θ}}} ,$$

an auxiliary diffusion network π_{ψ}(A|O), such as the generator score evaluator 225, is introduced and parameterized by ϵ_{ψ}. Training the diffusion policy is accomplished by optimizing ψ and treating p_{G}_{_{θ}} as the target action distribution,

$${min}_{ψ} {𝔼}_{{x}^{k} ∼ q ( {x}^{k} \vert {x}^{0} ) , {x}^{0} = s top - gra d ( {G}_{θ} ( z ) ) , z ∼ 𝒩 ( 0 , I ) , k ∼ 𝒰} [ λ ( k ) \cdot {‖ {ϵ}_{ψ} ( {x}^{k} , k ) - {ϵ}_{k} ‖}^{2} ] . \qquad Eq . ( 6 )$$

Then

$${s}_{{p}_{{π}_{ψ}}} ( {A}_{θ}^{k} )$$

can be obtained by applying ϵ_{ψ} to Equation (1) and

$${s}_{{p}_{{G}_{θ}}} ( {A}_{θ}^{k} )$$

in Equation (5) is approximated with

$${s}_{{p}_{{π}_{ψ}}} ( {A}_{θ}^{k} ) .$$

The action generator neural network model 120 (diffusion policy) parameters θ are iteratively updated by Equation (5), and the generator score evaluator 225 (diffusion policy) parameters ψ are updated by Equation (6). The parameters of the pre-trained (teacher 230) diffusion policy φ are fixed throughout the training. During inference, one-step sampling is directly performed according to Equation (3). The diffusion policy distillation is referred to as OneDP-S, where S denotes the stochastic policy.

A deterministic version of the action generator neural network model 120 is achieved by omitting random noise z, such that A_{θ}=G_{θ}(O), the distribution p_{G}_{_{θ}}, becomes a Dirac delta function centered at G_{θ}(O), that is, p_{G}_{_{θ}}=δ_{G}_{_{θ}}_{(O)}(A). Consequently,

$${s}_{{p}_{{G}_{θ}}} ( {A}_{θ}^{k} )$$

can be explicitly solved as follows:

$$\begin{matrix}{s}_{{p}_{{G}_{θ}}} ( {A}_{θ}^{k} ) = {∇}_{{A}_{θ}^{k}} log {p}_{θ} ( {A}_{θ}^{k} ) = {∇}_{{A}_{θ}^{k}} log {p}_{θ} ( {A}_{θ}^{k} \vert {A}_{θ} ) \\ = - \frac{{ϵ}_{k}}{{σ}_{k}} ; {A}_{θ}^{k} = {α}_{k} {A}_{θ} + {σ}_{k} {ϵ}_{k} , {ϵ}_{k} ∼ 𝒩 ( 0 , I )\end{matrix} . \qquad Eq . ( 7 )$$

By incorporating Equation (7) into Equation (5), a simplified loss function may be used without using the generator score evaluator 225:

$${∇}_{θ} {𝔼}_{k ∼ 𝒰} [ {𝒟}_{KL} ( {p}_{{G}_{θ} , k} ‖ {p}_{{π}_{ϕ} , k} ) ] = {𝔼}_{\begin{matrix}z ∼ 𝒩 ( 0 , I ) , k ∼ 𝒰 \\ {A}_{θ} = {G}_{θ} ( z , O ) \\ {A}_{θ}^{k} ∼ q ( {A}_{θ}^{k} \vert {A}_{θ} , k )\end{matrix}} [ \frac{w ( k )}{{σ}_{k}} ( {ϵ}_{ϕ} ( {A}_{θ}^{k} , k ) ) - {ϵ}_{k} ) {∇}_{θ} {A}_{θ}^{k} ] . \qquad Eq . ( 8 )$$

The deterministic diffusion policy distillation is referred to as OneDP-D. Pseudocode for the one-step diffusion policy training algorithm is shown in TABLE 1.

TABLE 1
One-Step Diffusion Policy Training Algorithm

| 1: | Inputs: action generator G_{θ}, generator score network π_{ψ}, |
|---|---|
| pre-trained diffusion policy π_{φ}. | |
| 2: | Initialization G_{θ} ← π_{φ}, π_{ψ} ← π_{φ}. |
| 3: | while not converged do |
| 4: | Sample A_{θ} = G_{θ}(z, O), z ~ [symbol] (0,l). |
| 5: | Diffuse A_{θ}^{k} = αₖA_{θ} + σₖ∈ₖ, ∈ₖ ~ [symbol] (0,l). |
| 6: | if OneDP-S then |
| 7: | Update ψ by Equation (6) |
| 8: | Update θ by Equation (5) |
| 9: | else if OneDP-D then |
| 10: | Update θ by Equation (8) |
| 11: | end if |
| 12: | end while |

The stochastic policy OneDP-S, which encompasses deterministic policies, is more versatile and better suited to scenarios requiring exploration, potentially leading to better convergence at a global optimum. OneDP-D simplifies the training process, though it may exhibit slightly weaker empirical performance.

FIG. 2B is a block diagram illustrating another example diffusion distillation system 250, according to at least one embodiment. The diffusion distillation system 250 trains the action generator neural network model 120 in the deterministic mode. Compared with the diffusion distillation system 200, the generator score network 225 is omitted and the noise input to the action generator neural network model 120 is also omitted. The diffusion policy distillation system 250 includes the action generator neural network model 120, the memory 110, the forward diffusion process 220, the pre-trained teacher 230, and parameter optimization unit 245, each of which may be implemented as software, hardware, or a combination. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the diffusion distillation system 250 is within the scope and spirit of embodiments of the present disclosure.

The action generator neural network model 120 processes the training images according to the diffusion policy parameters to generate predicted actions. The forward diffusion process 220 combines the predicted actions with training noise, producing noisy actions. In at least one embodiment, the amount of training noise increases as the training progresses. The pre-trained teacher 230 processes the noisy actions and computes scores. When the action generator neural network model 120 is trained in the deterministic mode, the parameter optimization unit 245 analytically computes predicted scores for the noisy actions. In at least one embodiment, an analytical score computation unit (not shown) is separate from the parameter optimization unit 245.

After training is complete, the action generator neural network model 120 may be used for inference, generating actions from images and noise, as shown in FIG. 1A. As a result of the diffusion distillation process, the action generator neural network model 120 is able to predict an action chunk in a single processing step, without iteration.

Conventionally, x⁰ is sampled by reversing the diffusion chain of a trained diffusion model, which involves discretizing the ODE as follows:

$${dx}^{k} = [ f ( k ) {x}^{k} - \frac{1}{2} {g}^{2} ( k ) {∇}_{{x}_{k}} log q ( {x}^{k} ) ] dk \qquad Eq . ( 9 )$$

where

$$f ( k ) = \frac{d log {α}_{k}}{dk} and {g}^{2} ( k ) = \frac{d {σ}_{k}^{2}}{dk} - 2 \frac{d log {α}_{k}}{dk} {σ}_{k}^{2} .$$

The unknown score ∇ₓ_{ₖ}logq(x^{k}) may be estimated as follows:

$$s ( {x}^{k} ) = {∇}_{{x}_{k}} log q ( {x}^{k} ) = - \frac{{ϵ}^{*} ( {x}^{k} , k )}{{σ}_{k}} \approx - \frac{{ϵ}_{θ} ( {x}^{k} , k )}{{σ}_{k}} ,$$

where ϵ*(x^{k}, k) is the true noise added at time k, and

$${s}_{θ} ( {x}^{k} ) = - \frac{{ϵ}_{θ} ( {x}^{k} , k )}{{σ}_{k}} .$$

The pre-trained teacher 230 is a diffusion model that has been extended to implement expressive and powerful diffusion policies for offline robotics. In robotics, a set of past observation images O is used as input to the policy. An action chunk A, which consists of a sequence of consecutive actions, forms the output of the policy.

$${π}_{θ} ( {A}_{t}^{0} \vert {O}_{t} ) := \int … \int 𝒩 ( {A}_{t}^{K} ; 0 , I ) {\prod }_{k = K}^{k = 1} {p}_{θ} ( {A}_{t}^{k - 1} \vert {A}_{t}^{k} , {O}_{t} ) {dA}_{t}^{K} … {dA}_{t}^{1} ,$$

where Oₜ contains the current and a few previous vision observation features at timestep t, and p_{θ} could be represented by ϵ_{θ}. The explicit form of

$${π}_{θ} ( {A}_{t}^{0} \vert {O}_{t} )$$

is often impractical que to the complexity of integrating actions from

$${A}_{t}^{K}$$

to

$${A}_{t}^{1} .$$

Conventionally, an action chunk prediction

$${A}_{t}^{0}$$

is obtained by iteratively solving Equation (9) from K to 0. As previously explained, predicting actions by iterative processing not sufficient for real-time robotic control. In at least one embodiment, the pre-trained teacher 230 learns the diffusion policies and predicts actions through iterative processing. As a result of the diffusion distillation process, the action generator neural network model 120 is a conditional diffusion-based action prediction model and is able to predict an action chunk in a single-step, without iteration.

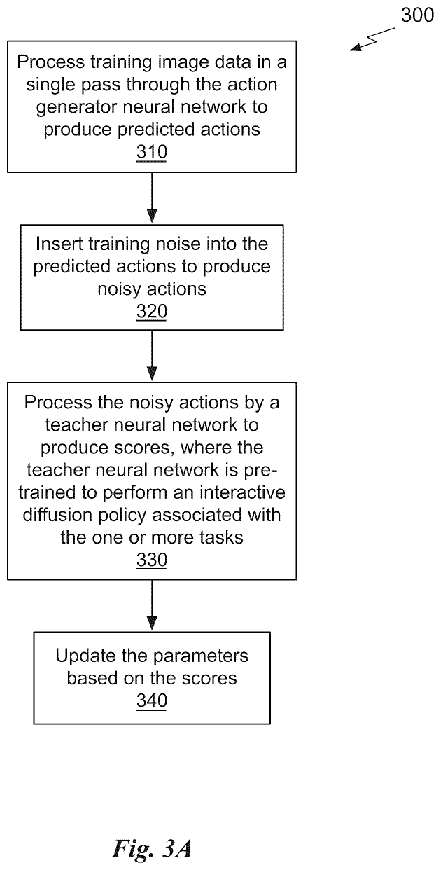

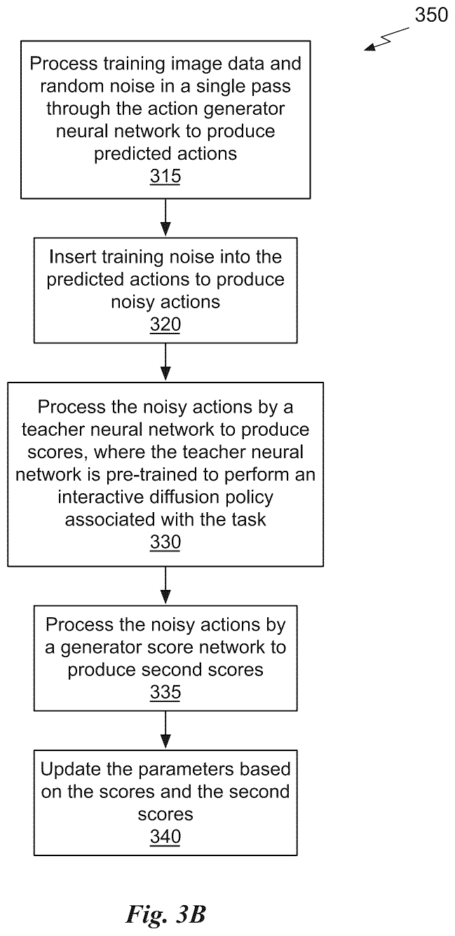

FIG. 3A illustrates a flowchart of a method 300 for training an action generator neural network model, according to at least one embodiment. In at least one embodiment, the method 300 implements the deterministic diffusion policy distillation OneDP-D. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the diffusion distillation system 250 of FIG. 2B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, training image data is processed in the single pass through the action generator neural network, according to the parameters, to produce predicted actions. In at least one embodiment, prior to the training, the parameters of the action generator neural network are initialized to equal or at least approximate pre-trained parameters of the teacher neural network. At step 320, training noise is inserted into the predicted actions to produce noisy actions.

At step 330, the noisy actions are processed by a teacher neural network to produce scores, where the teacher neural network is pre-trained to perform an iterative diffusion policy associated with the one or more tasks. At step 340, the parameters are updated based on the scores. In at least one embodiment, at least one of steps 310, 320, 330, or 340 is performed within a cloud computing environment. In at least one embodiment, at least one of steps 310, 320, 330, or 340 is performed for training, testing, or certifying a neural network employed in a machine, the robotic device, or autonomous vehicle. In at least one embodiment, at least one of steps 310, 320, 330, or 340 is performed on a virtual machine comprising a portion of a graphics processing unit. In at least one embodiment, at least one of steps 310, 320, 330, or 340 is implemented to include advanced error correction, fault-tolerance, or self-healing capabilities.

FIG. 3B illustrates a flowchart of another method 350 for training an action generator neural network model, according to at least one embodiment. In at least one embodiment, the method 300 implements the stochastic diffusion policy distillation OneDP-S. Each block of method 350, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 350 is described, by way of example, with respect to the diffusion distillation system 200 of FIG. 2A. However, this method may additionally or alternatively be executed by any one system, or any combination of systems, including, but not limited to, those described herein. Furthermore, persons of ordinary skill in the art will understand that any system that performs method 350 is within the scope and spirit of embodiments of the present disclosure.

At step 315, training image data and random noise is processed in the single pass through the action generator neural network, according to the parameters, to produce predicted actions. In at least one embodiment, prior to the training, the parameters of the action generator neural network are initialized to equal or at least approximate pre-trained parameters of the teacher neural network.

At step 320, training noise is inserted into the predicted actions to produce noisy actions. At step 330, the noisy actions by a teacher neural network to produce scores, where the teacher neural network is pre-trained to perform an iterative diffusion policy associated with the one or more tasks. At step 335, the noisy actions by a generator score network to produce second scores. At step 340, the parameters are updated based on the scores and the second scores. In at least one embodiment, at least one of steps 315, 320, 330, 335, or 340 is performed within a cloud computing environment. In at least one embodiment, at least one of steps 315, 320, 330, 335, or 340 is performed for training, testing, or certifying a neural network employed in a machine, the robotic device, or autonomous vehicle. In at least one embodiment, at least one of steps 315, 320, 330, 335, or 340 is performed on a virtual machine comprising a portion of a graphics processing unit. In at least one embodiment, at least one of steps 315, 320, 330, 335, or 340 is implemented to include advanced error correction, fault-tolerance, or self-healing capabilities.

The one-step diffusion policy (OneDP) diffusion distillation technique enhances the slow, iterative action prediction process of diffusion policy by reducing the diffusion processing to a single-step process. The reduced processing time dramatically decreases action inference time and enables a robot to respond quickly to environmental changes. As confirmed by extensive simulation and real-world experiments, OneDP not only achieves a slightly higher success rate, but also responds quickly and effectively to environmental interference. The rapid action prediction further allows the robot to complete tasks more efficiently. Additionally, by initializing the action generator neural network model and the generator score network with the identical pre-trained teacher, performance of the original model is preserved and/or enhanced, and only 2%-10% additional pre-training cost is incurred for the diffusion policy distillation to converge.

In some examples, the mode(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms-such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Parallel Processing Architecture

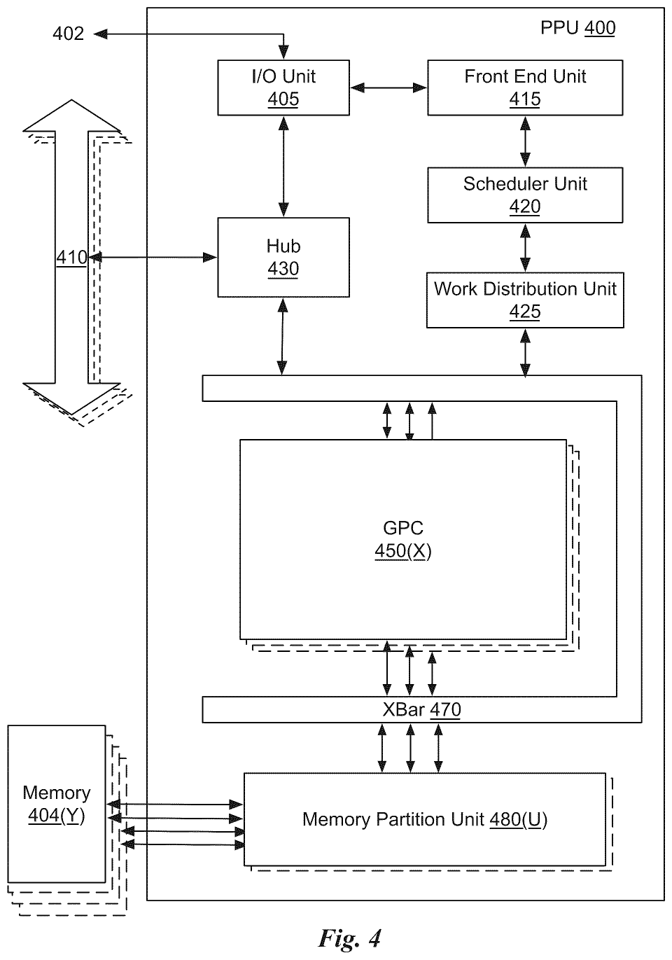

FIG. 4 illustrates a parallel processing unit (“PPU”) 400, according to at least one embodiment. The PPU 400 may be used to implement the one-step action generation system 100 and/or the diffusion distillation systems 200 and/or 250. The PPU 400 may be used to implement one or more of the action generator neural network model 120, the robotic control unit 130, the forward diffusion process 220, the pre-trained teacher 230, the generator score network 225, and the parameter optimization unit 240 and/or 245. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

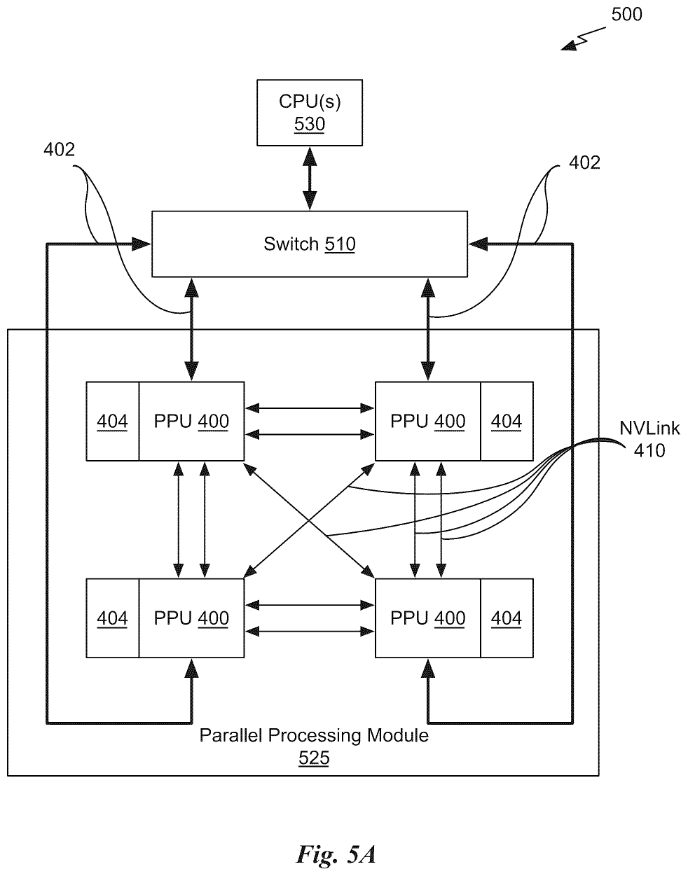

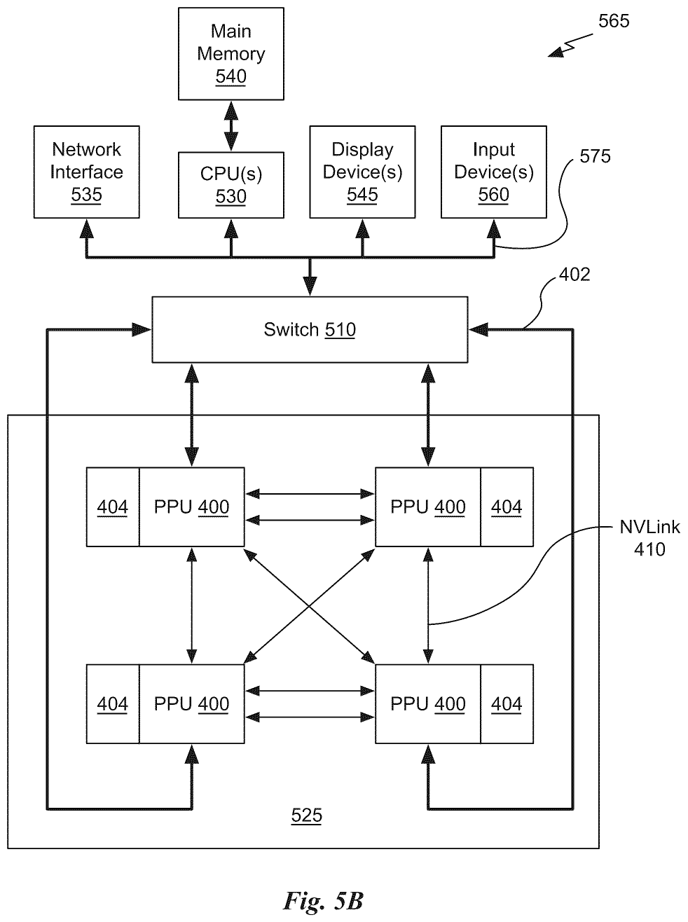

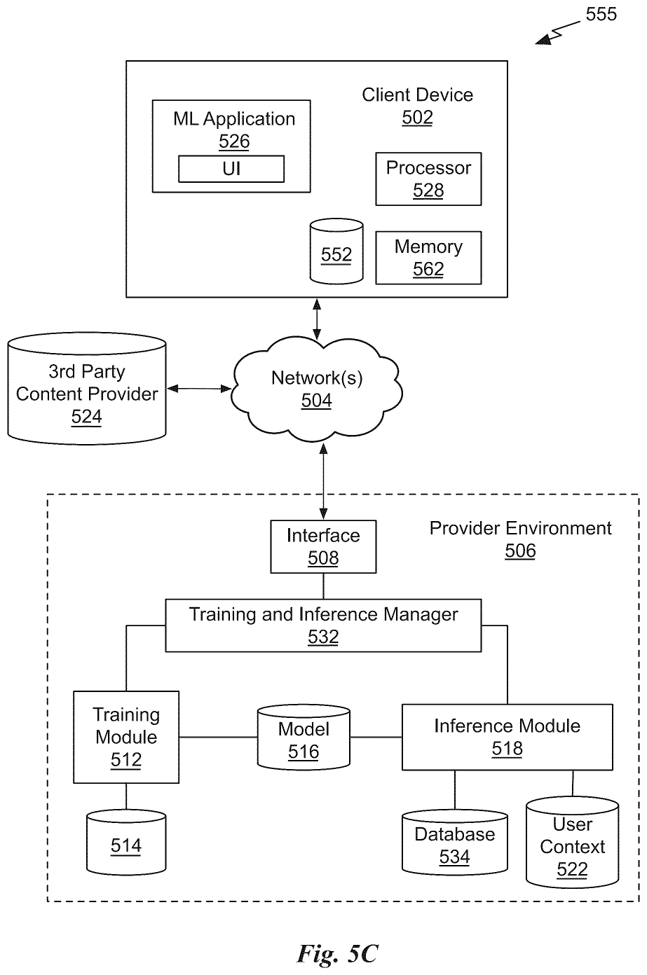

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A illustrates a processing system 500 implemented using the PPU 400 of FIG. 4, according to at least one embodiment. The exemplary system 500 may be configured to implement the method 150, 300, and/or 250 shown in FIGS. 1D, 3A, and/or 3B, respectively. The processing system 500 includes a CPU 530, switch 510, and multiple PPUs 400, and respective memories 404. The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented, according to at least one embodiment. The exemplary system 565 may be configured to implement the method 150, 300, and/or 250 shown in FIGS. 1D, 3A, and/or 3B, respectively. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates an exemplary system 555 that can be used to train a machine learning model, according to at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

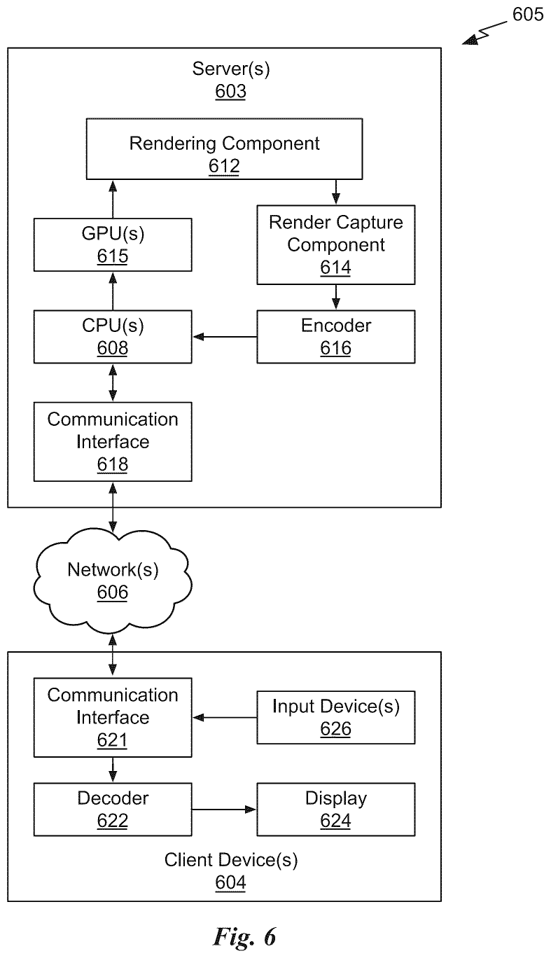

FIG. 6 illustrates an exemplary streaming system 605, according to at least one embodiment. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as one VPL, is a library that is utilized for accelerating video processing in one or more applications. In at least one embodiment, oneVPL implements various video decoding, encoding, and processing functions. In at least one embodiment, one VPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors @22@00, graphics cores @12@00, parallel processor @14@00, processor @17@00, processor core @17@00, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
obtaining image data corresponding to at least one viewpoint of one or more sensors associated with a robotic device; and
processing the image data and noise in a single pass through an action generator neural network, according to parameters of the action generator neural network that define a one-step diffusion policy, to produce one or more actions for controlling movement of the robotic device to perform one or more tasks.

2. The computer-implemented method of claim 1, wherein the one or more tasks comprise at least one of push, square, tool hang, transport, pick-and-place, lift, or can.

3. The computer-implemented method of claim 1, wherein the one-step diffusion policy defines the one or more tasks.

4. The computer-implemented method of claim 1, wherein the one-step diffusion policy is distilled from an iterative diffusion policy.

5. The computer-implemented method of claim 1, wherein the action generator neural network comprises an image encoder that processes at least the image data to produce one or more observation features.

6. The computer-implemented method of claim 1, wherein an object to which at least one task of the one or more tasks is applied is manipulated by an external force that is independent of the robotic device while the at least one task is performed.

7. The computer-implemented method of claim 6, wherein a next action of the one or more actions is produced responsive to obtaining image data depicting a result due to the external force.

8. The computer-implemented method of claim 1, wherein the at least one viewpoint includes at least one of a first viewpoint associated with a sensor located on the robotic device or a second viewpoint of a sensor used to capture image data depicting at least a portion of the robotic device.

9. The computer-implemented method of claim 1, wherein the action generator neural network is trained, at least in part, by:
processing training image data in the single pass through the action generator neural network to produce predicted actions;
inserting training noise into the predicted actions to produce noisy actions;
processing the noisy actions by a teacher neural network to produce scores, wherein the teacher neural network is pre-trained to perform an iterative diffusion policy associated with the one or more tasks; and
updating the parameters based on the scores.

10. The computer-implemented method of claim 9, further comprising, prior to the training, initializing the parameters of the action generator neural network to at least approximate pre-trained parameters of the teacher neural network.

11. The computer-implemented method of claim 1, wherein the action generator neural network is trained, at least in part, by:
processing training image data and random noise in the single pass through the action generator neural network to produce predicted actions;
inserting training noise into the predicted actions to produce noisy actions;
processing the noisy actions by a teacher neural network to produce scores, wherein the teacher neural network is pre-trained to perform an iterative diffusion policy associated with the one or more tasks;
processing the noisy actions by a generator score network to produce second scores; and
updating the parameters based on the scores and the second scores.

12. The computer-implemented method of claim 11, further comprising, prior to the training, initializing both the parameters of the action generator neural network and second parameters of the generator score network to at least approximate pre-trained parameters of the teacher neural network.

13. A system for generating action controls, comprising:
one or more processors to perform operations including:
obtaining image data corresponding to at least one viewpoint of one or more sensors associated with a robotic device; and
processing the image data and noise in a single pass through an action generator neural network, according to parameters of the action generator neural network that define a one-step diffusion policy, to produce one or more actions for controlling movement of the robotic device to perform one or more tasks.

14. The system of claim 13, wherein the one-step diffusion policy is distilled from an iterative diffusion policy.

15. The system of claim 13, wherein the action generator neural network comprises an image encoder that processes at least the image data to produce one or more observation features.

16. The system of claim 13, wherein an object to which at least one task of the one or more tasks is applied is manipulated by an external force that is independent of the robotic device while the at least one task is performed.

17. The system of claim 13, wherein the at least one viewpoint includes at least one of a first viewpoint associated with a sensor located on the robotic device or a second viewpoint of a sensor used to capture image data depicting at least a portion of the robotic device.

18. The system of claim 13, wherein the action generator neural network is trained, at least in part, by:
processing training image data in the single pass through the action generator neural network to produce predicted actions;
inserting training noise into the predicted actions to produce noisy actions;
processing the noisy actions by a teacher neural network to produce scores, wherein the teacher neural network is pre-trained to perform an iterative diffusion policy associated with the one or more tasks; and
updating the parameters of the action generator neural network based on the scores,
wherein prior to the training, the parameters of the action generator neural network are initialized to at least approximate pre-trained parameters of the teacher neural network.

19. The system of claim 13, wherein system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or
a system that incorporates one or more machine learning models deployed in a service or microservice along with an OS-level virtualization package (e.g., a container).

20. A processor comprising: one or more processing units to generate action controls by obtaining image data associated with a robotic device and process the image data and noise in a single pass through an action generator neural network, according to parameters that define a one-step diffusion policy, to produce one or more actions for controlling movement of the robotic device to perform a task, wherein the image data corresponds to at least one viewpoint.
